(19) United States
(12) Patent Application Publication
(10) Pub. No.: US 2025/0118922 A1
(43) Pub. Date: Apr. 10, 2025

(54) CONNECTOR

(71) Applicant: SUMITOMO WIRING SYSTEMS, LTD., Mie (JP)

(72) Inventors: Kazuya TAKEUCHI, Mie (JP); Norihito HASHIMOTO, Mie (JP); Kazuya KOBAYASHI, Mie (JP)

(21) Appl. No.: 18/833,928

(22) PCT Filed: Jan. 12, 2023
(86) PCT No.: PCT/JP2023/000551

§ 371 Date: Jul. 29, 2024

(30) Foreign Application Priority Data
Jan. 31, 2022 (JP) 2022-012601

(51) Int. Cl. H01R 13/424; H01R 12/72

(52) U.S. Cl. CPC H01R 13/424; H01R 12/722

(57) ABSTRACT

A housing (12) includes: a plurality of cavities (29) extending in a front-rear direction and arranged side by side in a width direction; a shared wall (34) disposed between the cavities (29) adjacent in the width direction; and a pair of lances (35A, 35B) protruding forward from the shared wall (34) and disposed to correspond to the cavities (29) adjacent in the width direction, respectively. The terminal fittings (11) are locked by the lances (35A, 35B) in the cavities (29). The pair of lances (35A, 35B) are arranged side by side in a height direction on the shared wall (34), and the housing (12) includes a shared space (41) that is open in front of the pair of lances (35A, 35B).

### TECHNICAL FIELD

The present disclosure relates to a connector.

### BACKGROUND

The connector disclosed in Patent Document 1 includes plug terminals and a plug body that receives the plug terminals. The plug terminals have terminal holes in each of the four sectors divided by cross-shaped slits.

The connector disclosed in Patent Document 2 includes a housing and a counterpart housing that can be fitted to each other. The housing has a rear fitting groove into which a rear guide protrusion of the counter part housing can be inserted.

### PRIOR ART DOCUMENT

### Patent Document

Patent Document 1: JP 2013-004281 A

Patent Document 2: JP 2014-107139 A

### SUMMARY OF THE INVENTION

### Problems to Be Solved

Generally, terminal fittings are disposed in cavities of a housing and locked by lances. Die-cutting holes for forming the lock surfaces of the lances are formed as openings in the front face of the housing by extracting a mold. If lances are formed on the walls that partition respective cavities adjacent to each other in the width direction, there is a concern that the housing may be enlarged in the width direction due to numerous die-cutting holes for cavities being opened in the front surface of the housing.

In view of the above, an object of the present disclosure is to provide a connector capable of avoiding enlarging the housing in the width direction.

### Means to Solve the Problem

A connector according to the present disclosure includes: a housing; and terminal fittings, wherein the housing includes: a plurality of cavities extending in a front-rear direction and arranged side by side in a width direction; a shared wall disposed between the cavities adjacent in the width direction; and a pair of lances protruding forward from the shared wall and disposed to correspond to the cavities adjacent in the width direction, respectively, wherein the terminal fittings are locked by the lances in the cavities, the pair of lances are disposed side by side in a height direction on the shared wall, and the housing includes a shared space that is open in front of the pair of lances.

### Effect of the Invention

According to the present disclosure, it is possible to provide a connector capable of avoiding the enlargement of the housing in the width direction.

### BRIEF DESCRIPTION OF THE DRAWINGS

FIG. 1 is a vertical cross-sectional view of a female connector and a male connector fitted together.

FIG. 2 is a side cross-sectional view of the female connector and the male connector fitted together.

FIG. 3 is a partially enlarged cross-sectional view of the female connector with the female connector and the male connector fitted together.

FIG. 4 is a front view of the female connector.

FIG. 5 is a front view and an enlarged view of an essential part of the housing.

FIG. 6 is an oblique top view of the housing.

FIG. 7 is an oblique front view of the male connector.

FIG. 8 is an oblique top view of the terminal fittings.

FIG. 9 is an oblique rear view of the housing.

### DETAILED DESCRIPTION TO EXECUTE THE INVENTION

### Description of Embodiments of the Present Disclosure

First, embodiments of the present disclosure will be listed and described.

(1) A connector according to the present disclosure includes: a housing; and terminal fittings, wherein the housing includes: a plurality of cavities extending in a front-rear direction and arranged side by side in a width direction; a shared wall disposed between the cavities adjacent in the width direction; and a pair of lances protruding forward from the shared wall and disposed to correspond to the cavities adjacent in the width direction, respectively, the terminal fittings are locked by the lances in the cavities, the pair of lances are disposed side by side in a height direction on the shared wall, and the housing includes a shared space that is open in front of the pair of lances.

As a pair of lances is arranged side by side on the shared walls at the height direction, it is possible to avoid enlarging the housing in the width direction. Moreover, as the housing includes a shared space that is open in front of the pair of lances, it is possible to easily form the front portions of the lances via the shared space.

(2) Preferably, the connector includes a counterpart housing, wherein the counterpart housing includes: a hood capable of being fitted to the housing; and a partitioning portion protruding in the hood and disposed in the shared space when the housing and the counterpart housing are fitted together.

Due to the partitioning portion being disposed in the shared space when the housing and the counterpart housing are fitted together, the cavities adjacent in the width direction are partitioned by the partitioning portion, so that the terminal fittings disposed in the respective cavities adjacent in the width direction can be kept insulated from each other.

(3) Preferably, the connector includes counterpart terminals protruding into the hood, wherein top ends in a protruding direction of the counterpart terminals are arranged to be set further back than top ends in a protruding direction of the partitioning portion.

If it is attempted to fit the housing and the counterpart housing together obliquely with respect to the proper posture, the housing abuts against the top ends in the protruding direction of the partitioning portion and avoids interfering with the counterpart terminals, such that the counterpart terminals can be placed in a protected state. In other words, angled fitting of the connector can be prevented. In particular, as the partitioning portion serves two functions of preventing angled fitting and maintaining the insulation between the terminal fittings, the structure of the counterpart housing can be simplified compared to the case in which these functions are served by different parts.

(4) Preferably, the terminal fittings each include a terminal body and a lock protrusion protruding from the terminal body, wherein, in the pair of terminal fittings disposed respectively in the cavities adjacent in the width direction, the lock protrusions are arranged side by side in the height direction in the shared space so as to be able to lock the pair of lances, respectively, and the lock protrusions protrudes in the height direction.

As the pair of terminal fittings are disposed side by side in the shared space and in the height direction, the pair of terminal fittings can be accommodated in the cavities with the gap between the terminal fittings reduced in the width direction. As a result, it is possible to more reliably avoid the enlargement of the housing in the width direction.

### Details of Embodiments of the Present Disclosure

Specific examples of the present disclosure will be described below with reference to the drawings. The present invention is not limited by these examples but indicated by the claims, and any modifications within the scope of and meaning equivalent to the claims are intended to be encompassed within the scope of the invention.

### First Embodiment

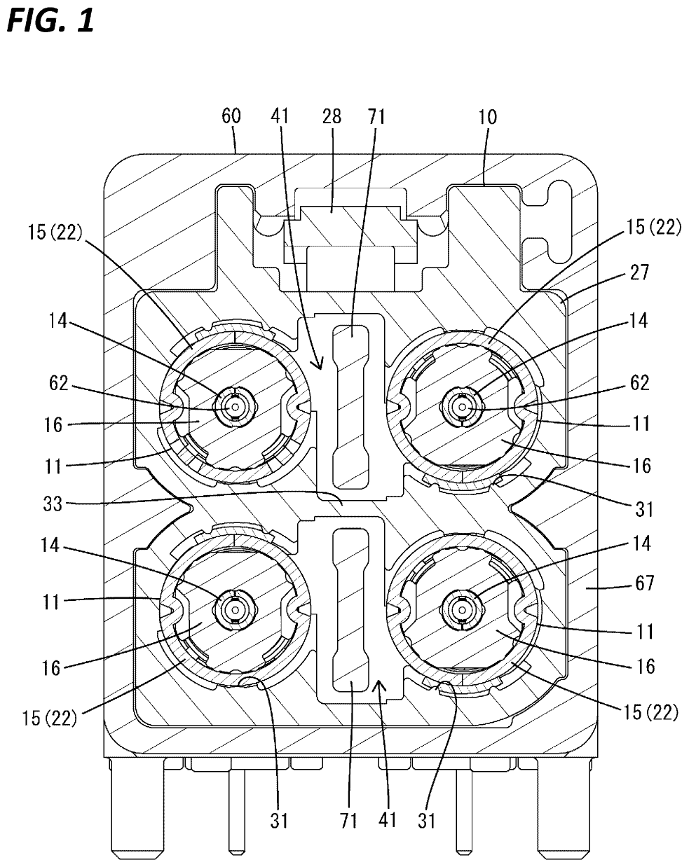

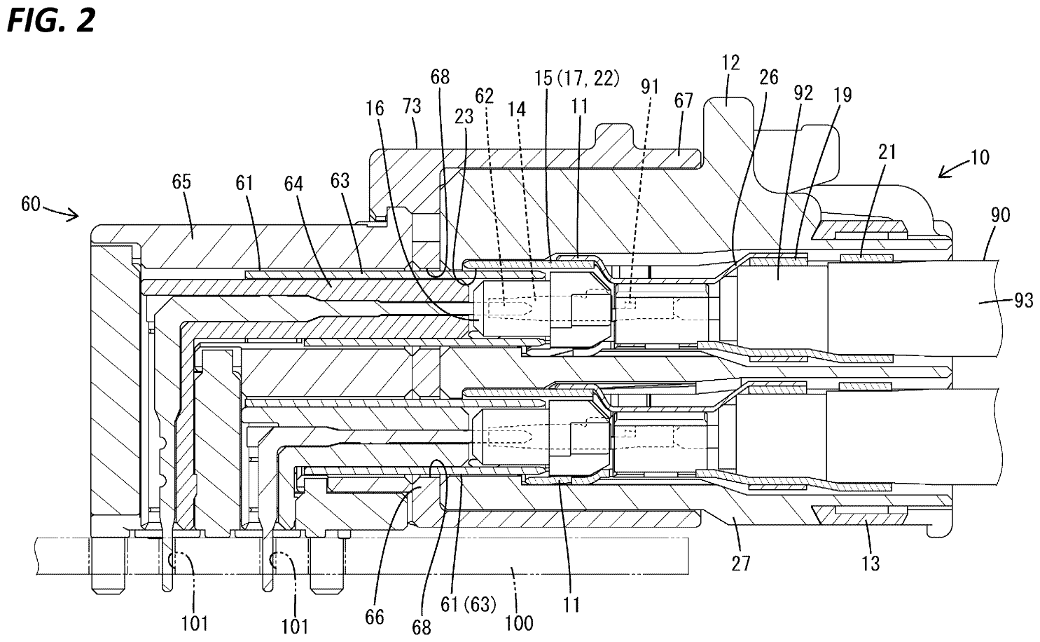

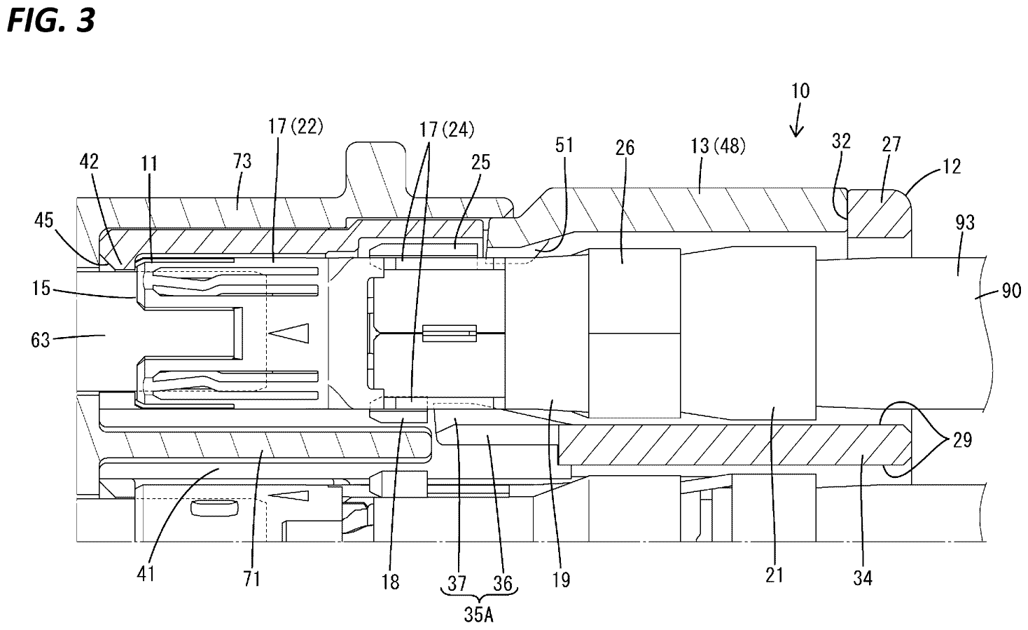

A connector according to a first embodiment of the present disclosure illustrates a shield connector. As shown in FIGS. 1 and 2, the connector is comprised of a female connector 10 and a male connector 60. The female connector 10 includes terminal fittings 11, a housing 12, and a retainer 13. As shown in FIG. 2, the male connector 60 is installed on a circuit board 100 and includes counterpart terminals 61 and a counterpart housing 73. The housing 12 and the counterpart housing 73 are adapted to be fitted to each other. It should be noted that, in the description below, regarding the front-rear direction, the side where the female connector 10 and the male connector 60 face each other when fitted together will be referred to as the front side. The vertical direction is as shown in each figure except for FIG. 3. Also, in the following description, the vertical direction is synonymous with the height direction, and the right and left direction is synonymous with the width direction. These reference orientations do not necessarily coincide with the orientations when the connector is mounted on a vehicle or the like, which is not shown in the drawings.

### Terminal Fittings

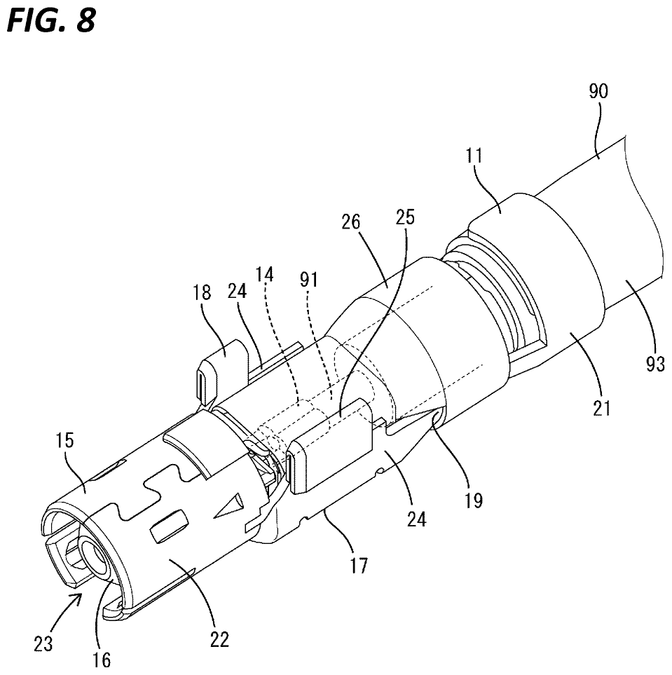

The terminal fittings 11 are coaxial terminals, and each includes, as shown in FIGS. 2 and 8, an inner conductor 14, an outer conductor 15 that surrounds the inner conductor 14, and a dielectric 16 disposed between the inner conductor 14 and the outer conductor 15. Although not shown in detail, the dielectric 16 is made of synthetic resin that accommodates the inner conductor 14 and maintains the insulation between the inner conductor 14 and the outer conductor 15. The inner conductor 14 is a plate made of a conductive metal in the shape of a circular pipe, and, as shown in FIG. 8, is electrically connected to a core wire 91 of an electric cable (coaxial cable) 90 at the rear end thereof.

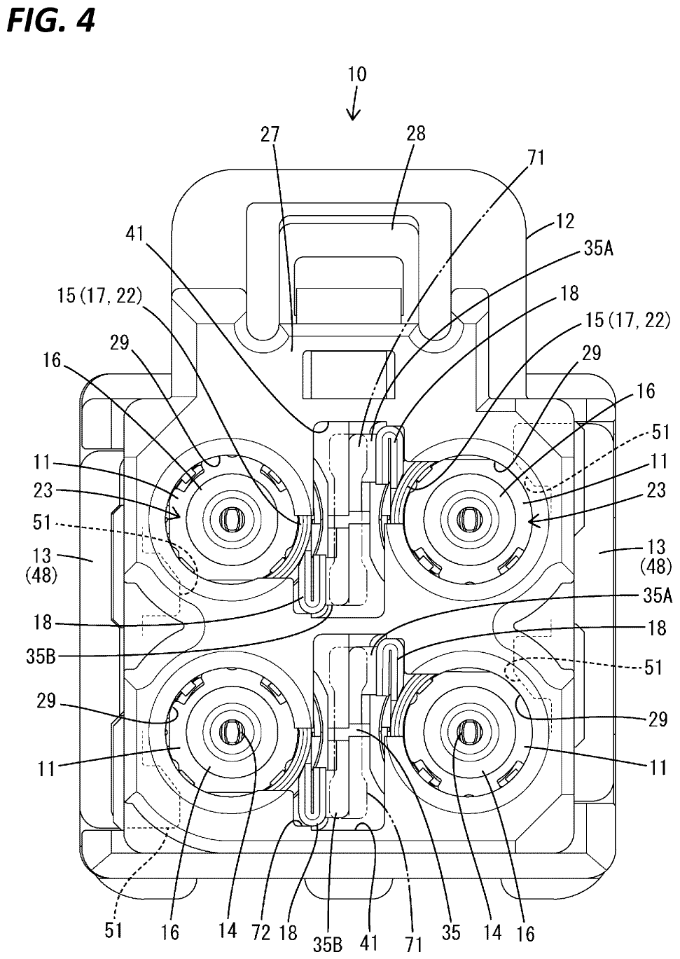

Each outer conductor 15 is a plate made of a conductive metal that includes a terminal body 17, a lock protrusion 18 protruding from the terminal body 17 in the height direction (see FIGS. 4 and 8), and barrels 19 and 21 provided in a line behind the terminal body 17. As shown in FIG. 2, the barrels include a shield barrel portion 19 crimped and electrically connected to a shield portion 92, such as a braided wire, of the electric cable 90, and a sheath barrel portion 21 mechanically connected by crimping to a sheath 93 of the electric cable 90 on the rear side of the shield barrel portion.

The terminal body 17 includes a tubular portion 22 having a cylindrical shape that receives the dielectric 16 therein. As shown in FIG. 2, formed between the front ends of the dielectric 16 and the tubular portion 22 is a terminal fitting space 23 in which an outer conductor tube 63, which will be described below, of the counterpart terminal 61 can be fitted.

As shown in FIG. 8, the terminal body 17 includes a pair of sidewalls 24 between the terminal body 17 and the shield barrel portion 19. The lock protrusion 18 has the shape of a rectangular plate protruding from one of the sidewalls 24, and doubly folded in the width direction as shown in FIG. 4. Formed on the other of the sidewalls 24 is a retainer lock protrusion 25 that is longer than the lock protrusion 18 in the front-rear direction. The retainer lock protrusion 25 also has the shape of a rectangular plate doubly folded in the width direction.

As shown in FIGS. 2, 3 and 8, the outer conductor 15 includes a cover 26 mounted on the terminal body 17. The cover 26 is disposed to cover the periphery of the joint of the inner conductor 14 and the core wire 91 between the sidewalls 24 and also covers the outer periphery of the shield barrel portion 19.

### Housing

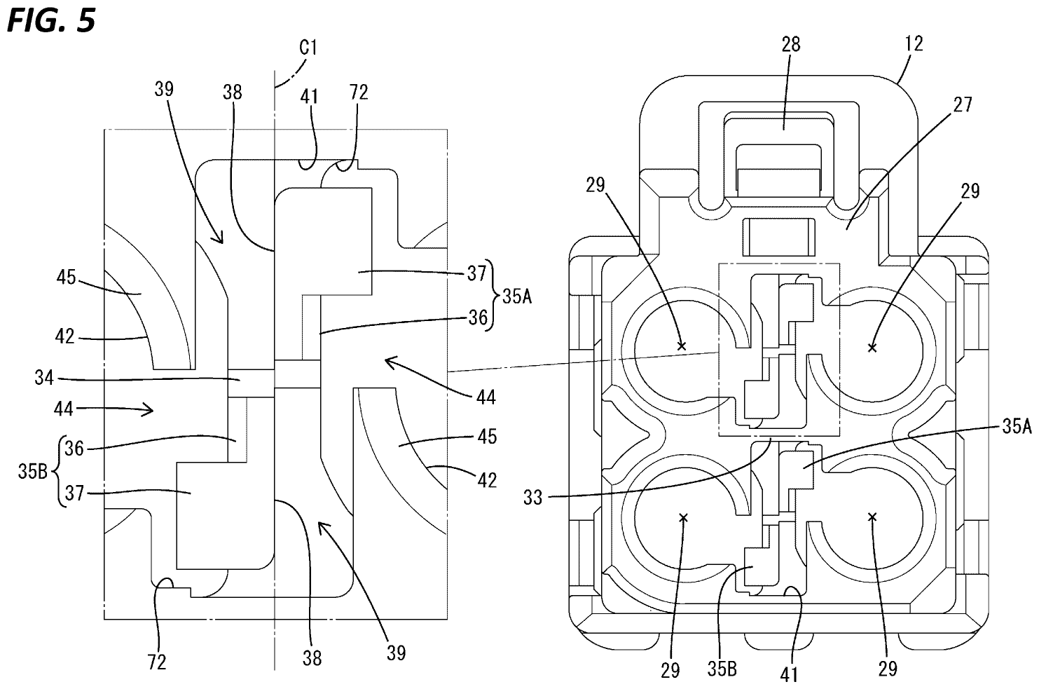

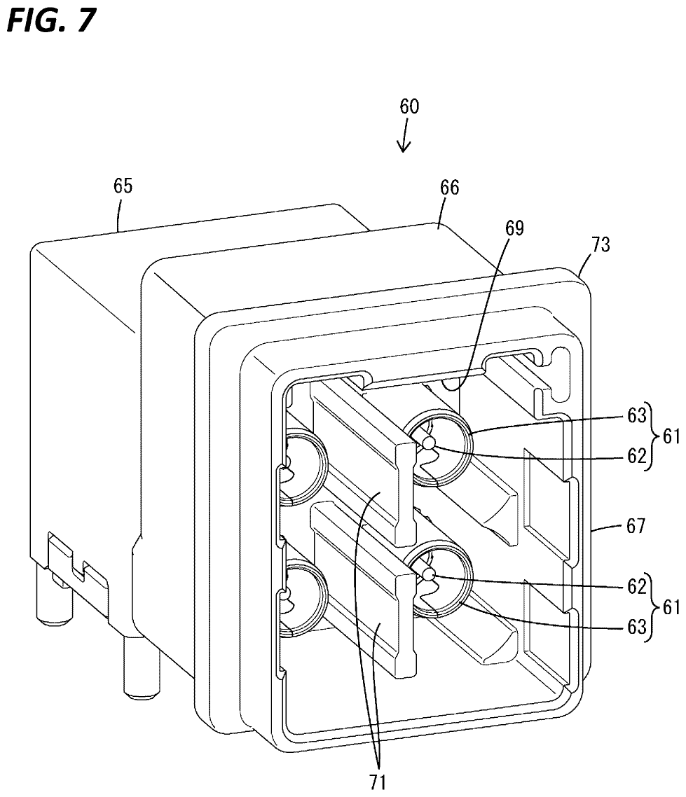

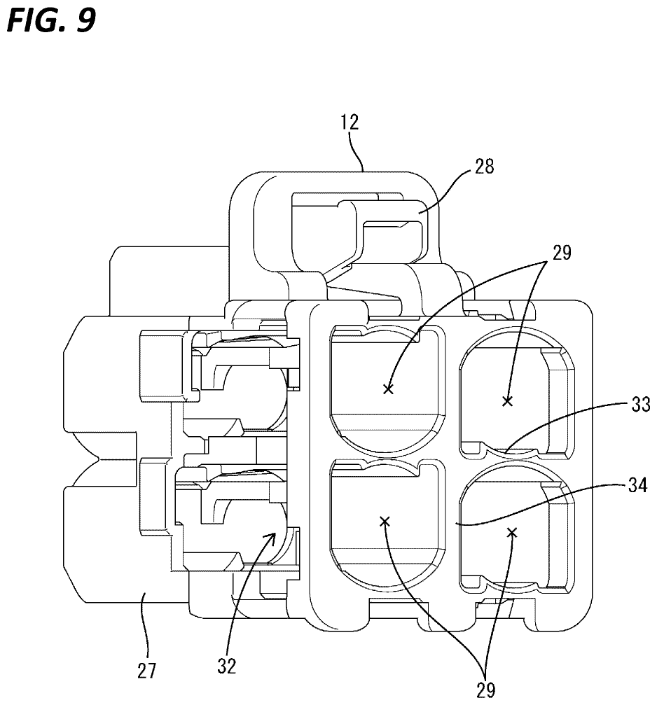

The housing 12 is made of a synthetic resin and includes a housing body 27 and a lock arm 28 protruding from the housing body 27 as shown in FIGS. 5 and 9. The lock arm 28 is shaped to extend rearward from the top surface of the housing body 27 so as to be able to deform in the vertical direction. The lock arm 28, although not shown, locks a counterpart lock portion 69 (see FIG. 7), which will be described below, of a counterpart housing 73 so as to keep the housing 12 and the counterpart housing 73 fitted together.

The housing body 27 includes a plurality of cavities 29. The cavities 29 are provided in pairs of upper and lower cavities in the housing body 27 with a plurality of cavities arranged side by side in the width direction in rows, two in a row in the first embodiment. Each cavity 29 penetrates the housing body 27 in the front-rear direction. The front portion of each cavity 29 has a circular cross-section into which a terminal fitting 11 can be inserted from the rear. As shown in FIG. 1, a backlash reduction rib 31 capable of contacting the tubular portion 22 of the terminal fitting 11 is formed in the inner peripheral surface at the front portion of each cavity 29.

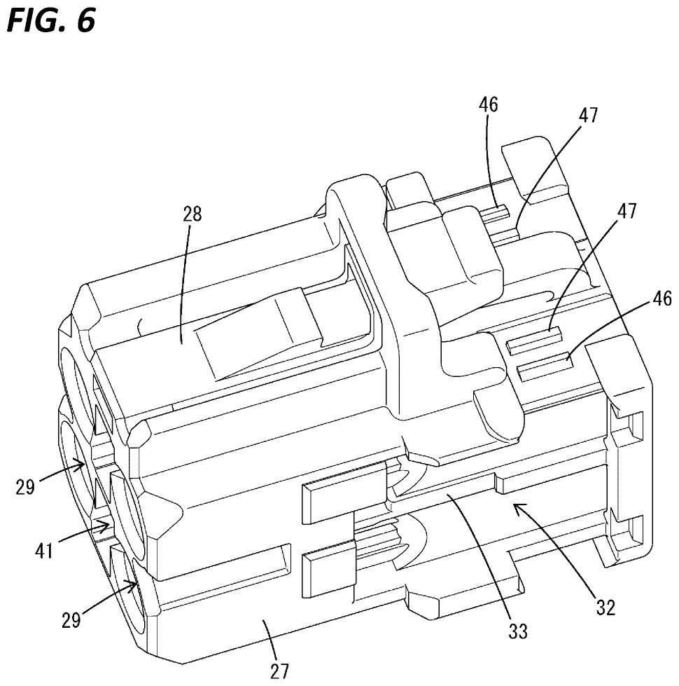

As shown in FIGS. 6 and 9, the housing body 27 includes a pair of retainer fitting holes 32. The retainer fitting holes 32 are opened in a rectangular shape in the right and left sidewalls of the housing body 27 and are in communication with the rear portion of the upper and lower cavities 29. As shown in FIG. 3, retainers 13 can be inserted laterally into the retainer fitting holes 32.

As shown in FIGS. 5 and 9, the housing body 27 includes, at the vertical center thereof, a lateral wall 33 that extends in the width direction to partition the upper and lower cavities 29. Additionally, as shown in FIGS. 3 and 9, the housing body 27 includes, at the lateral center thereof, a shared wall 34 that extends in the height direction to partition the rear portions of the right and left cavities 29. As shown in FIG. 9, the shared wall 34 and the lateral wall 33 intersect each other forming a cross shape at the rear portion of the housing body 27. The side surfaces of the shared wall 34 are visible from the sides of the housing body 27 through the retainer fitting holes 32.

As shown in FIG. 5, the housing body 27 includes a plurality of lances 35A and 35B that protrude forward from the shared wall 34. Each of the lances 35A and 35B is disposed to correspond to the respective cavity 29. A pair of lances 35A and 35B is disposed side by side on the shared wall 34 between the cavities 29 adjacent to each other in the width direction so as to be staggered in the height direction. Specifically, each pair of lances includes a first lance 35A disposed to correspond to the upper side of a cavity 29, and a second lance 35B disposed to correspond to the lower side of a cavity 29.

Each of the first lance 35A and the second lance 35B is identically shaped and has a plate-shaped lance body 36 that protrudes forward from the shared wall 34 and a lance protrusion 37 that protrudes from the lance body 36 into the corresponding cavity 29. The right and left plate surfaces of each lance body 36 are oriented in the width direction, and the lance bodies 36 of the first lance 35A and the second lance 35B are both formed within the wall thickness of the shared wall 34.

As shown in FIG. 5, of the right and left plate surfaces of each lance body 36, the widthwise inner plate surface on the center in the width direction of the housing body 27 is a perpendicular surface 38 that extends in the vertical direction. The perpendicular surface 38 of each of the first lance 35A and the second lance 35B is disposed along a center axis C1 passing through the center in the width direction of the housing body 27. A deformation space 39 is formed for each of the first lance 35A and the second lance 35B between the perpendicular surface 38 of the first lance 35A or the second lance 35B and the opposing cavity 29. The first lance 35A and the second lance 35B are capable of independently deforming in the deformation spaces 39.

A lance protrusion 37 protrudes from each of the upper front portion of the lance body 36 of the first lance 35A and the lower front portion of the lance body 36 of the second lance 35B. In other words, the lance protrusions 37 are disposed on the pair of lances 35A and 35B so as to be spaced apart in the height direction. The front surfaces of the lance protrusions 37 form the entire front surfaces of the lances 35A and 36B, and as shown in FIG. 3, are inclined forward as they go outward in the width direction (toward the top ends in the direction of protrusion). The dimension of protrusion of the lance protrusions 37 corresponds to the dimension of width (plate thickness) of the lock protrusions 18.

The housing body 27 includes shared spaces 41 that are open in front of each pair of the lances 35A and 35B. One shared space 41 is formed between the cavities 29 adjacent in the width direction. The cavities 29 adjacent in the width direction are placed in communication with each other in the front portions thereof via the shared spaces 41. The front surfaces of the lances 35A and 35B are visible from the front via the shared spaces 41.

As shown in FIG. 5, a rim portion 42 is formed on the front surface of the housing body 27 for each cavity 29 to define the edge of the opening of the cavity 29. Each rim portion 42 has a C-shape as seen from the front of the housing body 27 so that the break 44 between both ends of the C-shape is open where the lance 35A or 35B is located. As a result, the breaks 44 in the rim portions 42 of the cavities 29 adjacent in the width direction are staggered in the height direction to correspond to the first lance 35A and the second lance 35B. Each rim portion 42 includes a guide surface 45 tapering rearward and radially inward.

As shown in FIG. 6, the housing body 27 includes a plurality of temporary lock portions 46 and full lock portions 47 capable of locking the retainers 13. A pair of a temporary lock portion 46 and a full lock portion 47 protrudes from the right and left side portions of each of the upper and lower surfaces of the housing body 27.

### Retainer

A pair of retainers 13 is provided for each retainer fitting hole 32 (see FIG. 4). Each retainer 13 is made of a synthetic resin in the shape of a plate, and includes a plate-shaped cover portion 48 extending in the vertical direction and a pair of projecting pieces (not shown) that projects inward in the width direction (toward the center in the width direction of the housing body 27) from the upper and lower ends of the cover portion 48. The projecting pieces are provided to cover the upper and lower surfaces of the housing body 27 so that projecting pieces are adapted to be capable of locking the temporary lock portions 46 and the full lock portions 47 of the housing body 27.

The cover portions 48 have a rectangular shape as seen from the side to close the openings of the retainer fitting holes 32 at the side surfaces of the housing body 27. A plurality of restraining portions 51 capable of locking the terminal fittings 11 are provided on the inner surfaces in the width direction of the cover portions 48. As shown in FIG. 4, a pair of restraining portions 51 is provided for upper and lower cavities 29.

The retainers 13 are disposed movably between a temporary lock position and a full lock position with respect to the housing body 27. In the temporary lock position, the cover portions 48 are disposed laterally to the retainer fitting holes 32, and the projecting pieces are locked by the temporary lock portions 46 to restrain the movement of the retainers 13 in the width direction. In the temporary lock position, each restraining portion 51 is laterally retreated from the cavity 29 to permit the insertion of the terminal fitting 11 into the cavity 29. The retainers 13 can be pushed inward in the width direction to the full lock position. In the full lock position, the cover portions 48 block the openings of the retainer fitting holes 32, and the projecting pieces are locked by the full lock portions 47 to restrain the movement of the retainers 13 to the temporary lock position. As shown in FIG. 3, in the full lock position, each restraining portion 51 enters the cavity 29 to be able to position behind and lock the retainer lock protrusion 25 of the terminal fitting 11 disposed in the cavity 29. The terminal fitting 11 is restrained from slipping rearward out of the housing 12 by being locked by the restraining portion 51. It should be noted that, as described below, the terminal fitting 11 is primarily locked by the lances 35A and 35B before being locked by the restraining portion 51 of the retainer 13.

### Counterpart Terminal

As shown in FIG. 2, each counterpart terminal 61 includes a counterpart inner conductor 62, an outer conductor tube 63 serving as a counterpart outer conductor that surrounds the counterpart inner conductor 62, and a counterpart dielectric 64 disposed between the counterpart inner conductor 62 and the outer conductor tube 63. Although not shown in detail, the counterpart dielectric 64 is made of synthetic resin that receives the counterpart inner conductor 62 and maintains the insulation between the counterpart inner conductor 62 and the outer conductor tube 63. The counterpart inner conductor 62 is made of a conductive metal in the shape of a pin that is bent in an L-shape, and the lower rear end thereof is electrically connected by soldering to a connection hole 101 of the circuit board 100. The front end of the counterpart inner conductor 62 protrudes forward from the counterpart dielectric 64 to be inserted into the inner conductor 14 for electrical connection.

The outer conductor tube 63 has the shape of a cylinder. The front end of the outer conductor tube 63 is guided by the guide surface 45 of the rim portion 42 and fitted in the terminal fitting space 23 of the terminal fitting 11 for electrical connection with the outer conductor 15 of the terminal fitting 11 as shown in FIG. 3.

It should be noted that, as shown in FIG. 7, the male connector 60 includes an enclosure 65 made of die-casting material. The part of the counterpart inner conductor 62 that protrudes rearward from the outer conductor tube 63 is disposed within the enclosure 65. The outer conductor tube 63 is held by the enclosure 65 for electrical connection. The enclosure 65 is electrically connected by soldering to a conductive portion for grounding the circuit board 100 (see FIG. 2).

### Counterpart Housing

The counterpart housing 73 is made of a synthetic resin, and includes a counterpart housing body 66 and a tubular hood 67 protruding forward from the counterpart housing body 66 as shown in FIGS. 2 and 7. As shown in FIG. 2, the counterpart housing body 66 includes a plurality of insertion holes 68. Each insertion hole 68 is disposed in a location of the counterpart housing body 66 that corresponds to a respective cavity 29. Each insertion hole 68 has a circular cross-section to allow an outer conductor tube 63 to be inserted from behind.

The hood 67 has a rectangular barrel shape into which the housing 12 can fit. A counterpart lock portion 69 is formed on the upper wall of the hood 67. The front ends of the counterpart terminals 61 are disposed to project into the hood 67.

Formed inside the hood 67 is a pair of partitioning portions 71 protruding forward from the front surface of the counterpart housing body 66 (which also is the rear surface of the hood 67). Each partitioning portion 71 has the shape of a plate extending vertically with an I-shaped cross-section and, although not shown, is disposed in the center portion in the width direction of the counterpart housing 73 between the insertion holes 68 adjacent in the width direction. The partitioning portions 71 are disposed at the height locations that correspond to the respective upper and lower cavities 29. Moreover, each partitioning portion 71 is disposed between the front ends of the counterpart terminals 61 that are adjacent in the width direction. The front end of each partitioning portion 71 is located forward of the front ends of the counterpart terminals 61 in the hood 67.

If the housing 12 is attempted to be fitted to the counterpart housing 73 in an oblique direction during the course of fitting the housing 12 and the counterpart housing 73 together, the housing 12 interferes with the front ends of the partitioning portions 71, placing the counterpart terminals 61 in a protected state. In this way, angled fitting between the housing 12 and the counterpart housing 73 is prevented.

### Operational Effects of the Connector

The terminal fittings 11 are inserted into the cavities 29 of the housing 12 from At this moment, the terminal fittings 11 assume postures for insertion by behind. orienting the retainer lock protrusions 25 outward in the width direction and orienting the lock protrusions 18 inward in the width direction. Then, the terminal fittings 11 inserted into the cavities 29 that correspond to the first lances 35A assume postures for insertion that causes the lock protrusions 18 and the retainer lock protrusions 25 to protrude upward (see FIG. 4). Then, the terminal fittings 11 inserted into the cavities 29 that correspond to the second lances 35B assume postures for insertion that causes the lock protrusions 18 and the retainer lock protrusions 25 to protrude downward.

In the course of insertion of the terminal fittings 11, the lock protrusions 18 interfere with the respective lances 35A and 35B, thus deforming the lances 35A and 35B toward the deformation spaces 39. Once the terminal fittings 11 are properly inserted in the cavities 29, the lock protrusions 18 enter the shared spaces 41 to allow the lances 35A and 35B to elastically return and lock the rear edges of the lock protrusions 18. The terminal fittings 11 are primarily restrained from slipping rearward from the housing 12 by being locked by the lances 35A and 35B.

In the course of insertion of the terminal fittings 11, the lock protrusions 18 and the retainer lock protrusions 25 enter the guide grooves 72 (see FIGS. 4 and 5) of the cavities 29 to guide the insertion of the terminal fittings 11. If the posture of the terminal fittings 11 for insertion is different from the proper posture at the start of inserting the terminal fittings 11, the lock protrusions 18 and the retainer lock protrusions 25 fail to enter the guide grooves 72 and interfere with the rear surface of the housing 12. As a result, it is possible to prevent the terminal fittings 11 from being inserted into the cavities 29 in an incorrect posture. In other words, the lock protrusions 18 and the retainer lock protrusions 25 function as stabilizers of the terminal fittings 11.

Furthermore, when the terminal fittings 11 are removed from the cavities 29 due to maintenance or other reasons, an unshown unlock jig is abutted against the lances 35A and 35B via the breaks 44 in the rim portions 42 to deform the lances 35A and 35B toward the deformation spaces 39 to unlock the terminal fittings 11. In this state, the electric cables 90 are pulled back to slip the terminal fittings 11 out of the cavities 29.

In the case of the first embodiment, the first lances 35A and the second lances 35B are disposed side by side forward of the shared walls 34 in the height direction, forming the shared spaces 41 forward of the first lance 35A and the second lance 35B. As a result of the above, compared with the case in which lances are formed outward in the direction of the shared walls 34, the gap between the cavities 29 adjacent in the width direction can be reduced to avoid enlarging the housing 12 in the width direction.

Moreover, as the shared spaces 41 are formed when an unshown mold is pulled out that forms the front portions of the lances 35A and 35B, it is possible to improve the moldability of the lances 35A and 35B. In addition, the lock protrusions 18 protrude from the terminal body 17 in the height direction and are locked by the lance protrusions 37 within the widths of the lance protrusion 37. Therefore, there is little concern that the lock protrusions 18 enlarge the width of the housing 12.

Once the housing 12 is fitted to the counterpart housing 73, as shown in FIG. 1, the partitioning portions 71 of the counterpart housing 73 enters and are positioned in the shared spaces 41. As a result of the above, the partitioning portions 71 are positioned between the terminal fittings 11 that are adjacent in the width direction. Therefore, the insulation between the terminal fittings 11 adjacent in the width direction is maintained via the partitioning portions 71. It should be noted that, as shown in FIG. 3 with the housing 12 and the counterpart housing 73 properly fitted together, the front ends of the partitioning portions 71 are disposed side by side with the lock protrusion 18 on the outside thereof in the width direction. The partitioning portions 71 and the lances 35A and 35B are disposed to oppose each other in the front-rear direction.

As described above, according to the first embodiment, as the lances 35A and 35B are disposed side by side in the height direction on the shared walls 34, it is possible to avoid enlarging the housing 12 in the width direction. Moreover, due to the partitioning portions 71 disposed in the shared spaces 41, the cavities 29 adjacent in the width direction are partitioned by the partitioning portions 71, so that the terminal fittings 11 adjacent in the width direction can be kept insulated from each other.

### Other Embodiments of the Present Disclosure

The first embodiment disclosed herein should be considered to be illustrative in all respects and not restrictive.

In the case of the first embodiment, the terminal fittings are configured as coaxial terminals. However, according to other embodiments, the terminal fittings may be general terminals connected to electric cable without outer conductors or dielectrics and also without shield portions. Similarly, the counterpart terminals may also be general terminals without outer conductor tubes or counterpart dielectrics.

In the case of the first embodiment, the shared spaces are divided into upper and lower portions via a lateral wall. However, according to other embodiments, the shared spaces may be integrated by penetration through the lateral wall. If the shared spaces are integrated, the upper and lower partitioning portions may also be integrated so that only one partitioning portion may be formed on the counterpart housing.

In the case of the first embodiment, the shared walls, the lances, and the spaces are formed in the female connector. According to other embodiment, however, the shared walls, the lances, and the spaces are formed in the male connector.

In the case of the first embodiment, the housing includes two pairs of lances, each consisting of a first lance and a second lance. However, according to other embodiments, the housing may have only one pair of lances or three or more pairs of lances.

### LIST OF REFERENCE NUMERALS

10 Female connector
11 Terminal fitting
12 Housing
13 Retainer
14 Inner conductor
15 Outer conductor
16 Dielectric
17 Terminal body
18 Lock protrusion
19 Shield barrel portion (barrel)
21 Sheath barrel portion (barrel)
22 Tubular portion
23 Terminal fitting space
24 Sidewall
25 Retainer lock protrusion
26 Cover
27 Housing body
28 Lock arm
29 Cavity
31 Backlash reduction rib
32 Retainer fitting hole
33 Lateral wall
34 Shared wall
35A First lance (lance)
35B Second lance (lance)
36 Lance body
37 Lance protrusion
38 Perpendicular surface
39 Deformation space
41 Shared space
42 Rim portion
44 Break
45 Guide surface
46 Provisional lock portion
47 Full lock portion
48 Cover portion
51 Restraining portion
60 Male connector
61 Counterpart terminal
62 Counterpart inner conductor
63 Outer conductor tube
64 Counterpart dielectric
65 Enclosure
66 Counterpart housing body
67 Hood
68 Insertion hole
69 Counterpart lock portion
71 Partitioning portion
72 Guide groove
73 Counterpart housing
90 Electric cable
91 Core wire
92 Shield portion
93 Sheath
100 Circuit substrate
101 Connection hole
C1 Center axis

1. A connector comprising:
a housing; and
terminal fittings,
wherein the housing includes:
a plurality of cavities extending in a front-rear direction and arranged side by side in a width direction;
a shared wall disposed between the cavities adjacent in the width direction; and
a pair of lances protruding forward from the shared wall and disposed to correspond to the cavities adjacent in the width direction, respectively, and
the terminal fittings are locked by the lances in the cavities,
the pair of lances are disposed side by side in a height direction on the shared wall,
the housing includes a shared space that is open in front of the pair of lances,
the pair of lances includes a first lance that corresponds to an upper side of the cavity, and a second lance that corresponds to a lower side of the cavity,
the first lance and the second lance each include: a lance body that protrudes forward from the shared wall; and a lance protrusion that protrudes in the width direction from the lance body toward the corresponding cavity, the lance protrusion being capable of locking the terminal fitting,
the lance protrusion of the first lance is provided on an upper portion of the lance body of the first lance, and
the lance protrusion of the second lance is provided on a lower portion of the lance body of the second lance.

2. The connector according to claim 1 further comprising a counterpart housing,
wherein the counterpart housing includes:
a hood capable of being fitted to the housing; and
a partitioning portion protruding in the hood and disposed in the shared space when the housing and the counterpart housing are fitted together.

3. The connector according to claim 1 further comprising counterpart terminals protruding into the hood,
wherein the top ends in a protruding direction of the counterpart terminals are arranged to be set further back than the top ends in the protruding direction of the partitioning portion.

4. The connector according to claim 1, wherein
the terminal fittings each include a terminal body and a lock protrusion protruding from the terminal body, and
in the pair of terminal fittings disposed respectively in the cavities adjacent in the width direction, the lock protrusions are arranged side by side in the height direction in the shared space so as to be able to lock the pair of lances, respectively, and the lock protrusions protrude in the height direction.

5. The connector according to claim 4, wherein the lock protrusions protruding in the height direction are locked by the lance protrusions within the width of the lance protrusions.

6. The connector according to claim 1, wherein a rim portion is provided on a front surface of the housing body for each of the adjacent cavities to determine an edge of an opening of the cavity, and a break is provided that is open between both ends of the rim portion, the lance protrusion facing the break.
